(19) United States
(12) Patent Application Publication
(10) Pub. No.: US 2026/0121127 A1
(43) Pub. Date: Apr. 30, 2026

(54) Method of Producing Solid-State Battery Pack Comprising Internally Connected Bipolar Electrodes

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/763,449

(22) Filed: Jul. 3, 2024

(51) Int. Cl. H01M 10/0585; H01M 4/02; H01M 4/04; H01M 4/1391; H01M 4/36; H01M 4/62; H01M 10/0525; H01M 10/0565; H01M 50/403; H01M 50/437; H01M 50/491; H01M 50/497; H01M 50/512

(52) U.S. Cl. CPC H01M 10/0585; H01M 4/0404; H01M 4/0407; H01M 4/0409; H01M 4/043; H01M 4/0471; H01M 4/1391; H01M 4/364; H01M 4/622; H01M 10/0525; H01M 10/0565; H01M 50/403; H01M 50/437; H01M 50/491; H01M 50/497; H01M 50/512; H01M 2004/027; H01M 2004/028; H01M 2004/029; H01M 2300/0094

(57) ABSTRACT

A substantially liquid solvent-free method of producing a bipolar battery pack, comprising: (a) providing a first set of multiple bipolar electrodes and at least one or multiple ion-permeable separator layers, wherein the bipolar electrode comprises (i) a current collector; (ii) a cathode layer (prepared using a solid-state method) disposed on a first primary surface; and (iii) an anode layer deposited on the opposing primary surface; (b) stacking the bipolar electrodes alternately with the separator layers for connecting the multiple bipolar electrodes in series to form a stack in such a manner that a separator is disposed between the anode layer of a bipolar electrode and the cathode layer of a neighboring bipolar electrode; (c) applying a pressure and/or heat to the stack to consolidate the stack for forming a battery module; and (d) optionally encasing the module with a protective housing to form a pack.

### FIELD

The present invention provides bipolar electrodes, a bipolar solid-state lithium battery module or pack containing multiple bipolar electrodes connected in series and/or in parallel, and manufacturing methods for the bipolar electrode and the bipolar battery pack.

### BACKGROUND

Rechargeable lithium-ion (Li-ion) and lithium metal batteries (e.g., lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode)1.

However, the electrolytes used for lithium-ion batteries and all lithium metal secondary batteries pose some safety concerns. Most of the organic liquid electrolytes can cause thermal runaway or explosion problems.

Solid state electrolytes are commonly believed to be safe in terms of fire and explosion proof. Solid state electrolytes can be divided into organic, inorganic, organic-inorganic (or polymer-inorganic) composite electrolytes. However, the conductivity of organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm).

Although the inorganic solid-state electrolyte (e.g., garnet-type and metal sulfide-type) can exhibit a high conductivity (about 10⁻³ S/cm), the interfacial impedance or resistance between the inorganic solid-state electrolyte and the electrode (cathode or anode) is high. Further, the traditional inorganic ceramic electrolyte is very brittle and has poor film-forming ability and poor mechanical properties. These materials cannot be cost-effectively manufactured into thin films or a layer format.

In a related topic, bipolar batteries are lithium batteries that include internally stacked electrodes connected in series. In contrast to conventional lithium-ion batteries, these electrodes have a “bipolar” current collector structure. This means that the active materials for the cathode of the battery and the active materials for the anode are applied to the opposing primary surfaces of a current collector or common electrode carrier. The individual lithium-ion cells are then no longer packed separately in aluminum housings, but only the finished electrode stack (or a multi-cell battery module or pack) is given a fixed housing. This significantly reduces or eliminates the need for housing components and connecting cables, which saves costs and space in an electric vehicle. The reduced amount of connecting wires or cables results in a lower internal resistance and higher power. The space freed up can be filled with more active material. This allows the battery to store more energy and increases the vehicle's range. This is an attractive feature of lithium-ion bipolar batteries. A stringent condition for a bipolar battery to work is having an electrolyte not being allowed to migrate from one battery cell to another. This condition has essentially eliminated the use of a liquid electrolyte.

Hence, a general object of the present invention is to provide a safe, flame/fire-resistant, solid-state electrolyte system for a rechargeable bipolar lithium battery module or pack. Safe bipolar unit cells are internally connected in series to form a module and multiple modules are internally connected in parallel to form a pack. This electrode-to-module or electrode-to-pack strategy eliminates the need to make multiple cells first that are then externally connected to form a higher voltage module or pack using excessive amounts of connectors, welds, casings, etc.

### SUMMARY

The present disclosure provides a method of producing a bipolar battery module or pack, the method comprising:
(a) Providing a first set of multiple bipolar electrodes and at least one or multiple ion-permeable separator layers, wherein at least one bipolar electrode is prepared by (A) providing a current collector comprising a conductive material foil having a thickness from 10 nm to 100 μm and two opposing primary surfaces, herein referred to as a first primary surface and a second primary surface, respectively; (B) preparing a positive electrode (cathode) layer disposed on the first primary surface by (i) dispensing, spraying, coating, casting, or extruding to deposit a mixture of functional solid particles onto the first primary surface to form a mixture layer comprising solid particles of a cathode active material, an optional conductive additive, an optional binder resin, and a first polymer electrolyte having a lithium salt dispersed therein, which is a solid polymer electrolyte being substantially free from a liquid solvent and having a lithium ion conductivity no less than 1.0×10⁻⁸ S/cm at room temperature and (ii) optionally applying a pressure, heat, or both pressure and heat to consolidate said mixture layer to form said positive electrode layer; and (C) optionally depositing a negative electrode (anode) layer on the second primary surface wherein the negative electrode (anode) layer comprises a lithium metal layer or a layer of a mixture of solid particles of an anode active material, an optional conductive additive, an optional binder resin, a second polymer electrolyte having a lithium salt dispersed therein, which is different than or the same as the first electrolyte;
(b) stacking the bipolar electrodes and separator layers alternately to form a battery stack comprising bipolar cells internally connected in series;
(c) exerting a pressure along a stacking direction or a pressure and heat to the battery stack to form a bipolar module; and
(d) optionally encasing the module with a housing element to form a pack.
   In this method, step (b) and step (c) may further comprise forming at least another module in a similar manner and connecting the resulting multiple modules in parallel, and step (c) comprises encasing the parallel-connected multiple modules with a protective housing element to form a pack.

Preferably, step (b) and step (c) further comprise forming at least another module in a similar manner and internally connecting the resulting multiple modules in parallel, and step (d) comprises encasing the parallel-connected multiple modules with a protective housing element to form a pack.

In certain embodiments, the pressure in step (c) is from 0.1 to 1,000 psi, the temperature is from 25° C. to 400° C., and the period of time is from 10 seconds to 5 hours. The magnitude of the pressure applied to the stack/module or pack depends upon the type of polymer electrolyte used. A lower pressure would be needed if the polymer electrolyte contains some liquid or is a gel polymer electrolyte. The temperature needed depends upon the proper dissolution temperature or the glass transition or melting point of the polymer.

In some preferred embodiments, step a) and/or step b) comprises depositing a positive electrode layer, a negative electrode layer, and/or an ion-permeable separator layer in a reel-to-reel or roll-to-roll manner. It is highly advantageous to prepare a bipolar electrode in a reel-to-reel or roll-to-roll manner.

Preferably, the cathode layer, the anode layer, and/or the ion-permeable separator layer comprises particles of an inorganic solid-state electrolyte and/or particles of a ceramic or glass material. The inorganic solid electrolyte is preferably selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof and wherein the particles of ceramic or glass material is selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

The first or second polymer electrolyte may comprise a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

In some embodiments, the negative electrode (or anode) layer in step a) is produced by (i) spraying, coating, casting, or extruding to deposit a powder mixture layer of functional solid particles onto the second primary surface to form a mixture layer comprising solid particles of an anode active material, an optional conductive additive, an optional binder resin, and a second polymer electrolyte having a lithium salt dispersed therein, which is a solid polymer electrolyte being substantially free from a liquid solvent and having a lithium ion conductivity no less than 1.0×10⁻⁸ S/cm at room temperature and (ii) optionally applying a pressure, heat, or both pressure and heat to consolidate the powder mixture layer to form the negative electrode (anode) layer.

In some preferred embodiments, at least one of the ion-permeable separator layers is prepared by (i) spraying, coating, casting, or extruding to deposit a powder mixture layer of solid particles onto a surface of the negative electrode (anode) layer of a bipolar electrode and/or a surface of the positive electrode (cathode) layer of a neighboring bipolar electrode to form a mixture layer comprising a polymer and solid particles of an inorganic solid electrolyte and/or solid particles of a ceramic or glass material and (ii) optionally applying a pressure, heat, or both pressure and heat to consolidate the mixture layer to form the ion-permeable separator layer.

The ion-permeable separator layer may be selected from a porous polymer membrane, a nonwoven fabric, a polymer electrolyte, an inorganic solid-state electrolyte, a polymer composite electrolyte comprising particles of an inorganic solid-state electrolyte dispersed in a polymer matrix, or a polymer composite electrolyte comprising particles of a ceramic or glass material dispersed in a polymer matrix. The particles of ceramic or glass material is preferably selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

In certain embodiments of the present disclosure, at least one of the ion-permeable separator layers, positive electrode layers, and anode electrode layers comprises a flame retardant selected from an organic phosphorus compound, an inorganic phosphorus compound, a halogenated derivative thereof, or a combination thereof. The organic phosphorus compound or the inorganic phosphorus compound may be selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

In certain embodiments, the method comprises at least one of the following procedures: (i) depositing the positive electrode layer by dispensing or spraying a mixture of solid particles onto the first primary surface to form a mixture layer wherein the step of dispensing or spraying comprises metering and dispensing the mixture of solid particles to form a solid powder mixture layer having a thickness from 0.1 μm to 2,000 μm on the first primary surface with or without imparting charges to the solid powder mixture; (ii) depositing the negative electrode layer by dispensing or spraying a mixture of solid particles onto the second primary surface to form a mixture layer wherein the step of dispensing or spraying comprises metering and dispensing the mixture of solid particles to form a solid powder mixture layer having a thickness from 0.1 μm to 2,000 μm on the second primary surface with or without imparting charges to the solid powder mixture, which comprises the mixture of solid particles of an anode active material, an optional conductive additive, an optional binder resin, a second polymer electrolyte having a lithium salt dispersed therein; and (iii) depositing an ion-permeable separator layer by dispensing, onto a solid substrate surface, a solid powder mixture layer comprising a polymer and solid particles of an inorganic solid electrolyte and/or solid particles of a ceramic or glass material, wherein the solid substrate surface is a surface of a positive electrode layer, a negative electrode layer, or an ion-permeating membrane and wherein the dispensing procedure is conducted with or without imparting charges to the solid powder mixture.

The presently disclosed method is capable of producing a wide variety of solid-state bipolar lithium battery modules/packs that are safe, of high energy density, high power density, and lower costs. In some examples, this method can produce a bipolar battery pack comprising one or a plurality of modules wherein at least one module comprises a first set of multiple bipolar electrodes internally connected in series, wherein at least one of the bipolar electrodes comprises: a) A current collector comprising a conductive material foil having a thickness from 10 nm to 100 μm and two opposing primary surfaces; b) a positive electrode (cathode) layer disposed on one of the two primary surfaces (also herein referred to as a first primary surface), wherein the positive electrode layer comprises a mixture of particles of a cathode active material, an optional but typically desired conductive additive, an optional binder resin, and a first polymer or polymer hybrid/composite electrolyte preferably comprising a mixture of an inorganic solid-state electrolyte and a solid polymer electrolyte, wherein the solid polymer electrolyte comprises a polymer, having a lithium ion conductivity no less than 1.0×10⁻⁸ S/cm and a polymer-to-lithium salt weight ratio of from 1/100 to 100/1; and c) either (i) a negative electrode (anode) layer deposited on the opposing primary surface (also herein referred to as the second primary surface) wherein the negative electrode (anode) layer comprises a lithium metal layer or a mixture of particles of an anode active material, a solid polymer or polymer hybrid/composite electrolyte, and, optionally, particles of a solid inorganic solid-state electrolyte wherein the solid polymer comprises a lithium salt dispersed therein with a polymer-to-lithium salt weight ratio of from 1/100 to 100/1 or (ii) initially without a negative electrode layer deposited on said opposing primary surface (so-called “anodeless”) when the battery pack is made (a lithium metal layer is formed when the battery pack is charged); wherein the multiple bipolar electrodes are connected in series in such a manner that an ion-permeable separator or solid-state electrolyte layer is disposed between the negative electrode layer (or the second primary surface, if anodeless initially) of a bipolar electrode and the positive electrode layer of a neighboring bipolar electrode.

In certain preferred embodiments, the bipolar battery pack comprise multiple sets (modules) of multiple bipolar electrodes internally connected in series and these multiple sets (modules) of multiple bipolar electrodes are internally connected in parallel. Preferably, the bipolar battery pack further comprises a protecting housing that encloses the multiple modules. There can be partitioning walls between internally arranged modules, if so desired.

The disclosed method enables the production of bipolar lithium battery modules and packs wherein the solid polymer electrolyte and the inorganic solid-state electrolyte, in combination, form a contiguous phase in the cathode, in the anode, or in both the anode and the cathode, and the contiguous phase is in a physical contact or ionic communication with the ion-permeable separator or solid-state electrolyte layer.

In certain embodiments, one or both of the primary surfaces of the conductive material foil (e.g., Al foil, Cu foil, stainless steel cell, etc.) is coated with a layer of graphene or expanded graphite sheets having a layer thickness from 1 nm to 50 μm. This could prevent lithium diffusion in the metal foil, which otherwise could degrade the function of a bipolar electrode

Alternatively, this conductive foil contains a laminate of two or more conductive materials laminated together. For instance, this can contain a layer of Cu (for supporting the negative electrode layer) and a layer of Al (for supporting the positive electrode layer) that are mechanically compressed or chemically bonded together. This can also be a Cu foil or Al foil coated with a layer of conductive polymer (e.g., an intrinsically conductive polymer or a polymer matrix containing conductive fillers dispersed therein; examples of conductive fillers being graphene sheets, carbon nanotubes, carbon fibers, carbon black particles, etc.).

Since the bipolar current collector can be a laminate of 2 or 3 conductive material films or foils mechanically or chemically bonded together face-to-face, the disclosure also provides a method of producing a bipolar battery pack, the method comprising:
a. Providing a first set of multiple bipolar electrodes and at least one or multiple ion-permeable separator layers, wherein at least one bipolar electrode is prepared by (A) providing a first current collector comprising a first conductive material foil having a thickness from 10 nm to 100 μm and two opposing primary surfaces, herein referred to as a first primary surface and a second primary surface, respectively; (B) preparing a positive electrode (cathode) layer disposed on the first primary surface to form a first half of the bipolar electrode, which is conducted by (i) dispensing, spraying, coating, casting, or extruding to deposit a mixture of functional solid particles onto the first primary surface to form a mixture layer comprising solid particles of a cathode active material, an optional conductive additive, an optional binder resin, and a first polymer electrolyte having a lithium salt dispersed therein, which is a solid polymer electrolyte being substantially free from a liquid solvent and having a lithium ion conductivity no less than 1.0×10⁻⁸ S/cm at room temperature and wherein the second surface is not deposited with a positive electrode layer or negative electrode layer; and (ii) optionally applying a pressure, heat, or both pressure and heat to consolidate said mixture layer to form said positive electrode layer; (C) providing a second current collector comprising a second conductive material foil, different than the first conductive material, having a thickness from 10 nm to 100 μm and two opposing primary surfaces, hereinafter referred to as the third primary surface and the fourth primary surface, respectively; and (D) either depositing a negative electrode (anode) layer on the third primary surface (or initially having no negative electrode layer deposited on the third primary surface) to obtain a second half of the bipolar electrode, wherein the negative electrode layer (anode active layer), if present, comprises (i) a lithium metal layer and/or (ii) a layer of a mixture of particles of an anode active material, an optional conductive additive, an optional binder resin, and a second polymer electrolyte comprising a lithium salt dispersed therein, and wherein the fourth surface is not deposited with a positive electrode layer or a negative electrode layer; and (E) combining the first half of the bipolar electrode and the second half of the bipolar electrode to form the bipolar electrode wherein the second primary surface and the fourth primary surface are mechanically compressed or chemically bonded back-to-back together;
b. stacking the multiple bipolar electrodes alternately with the layers of ion-permeable separator for connecting multiple bipolar electrodes in series to form a stack in such a manner that a layer of ion-permeable separator is disposed between the negative electrode layer of a bipolar electrode and the positive electrode layer of a neighboring bipolar electrode;
c. applying a pressure, heat, or both pressure and heat to the stack for a desired period of time to consolidate the stack for forming a battery module; and
d. optionally encasing the module(s) with a housing element to form a pack.
   In certain embodiments, step b) and step c) further comprise forming at least another module in a similar manner and connecting the resulting multiple modules in parallel, and step c) comprises encasing the parallel-connected multiple modules with a protective housing element to form a pack.

In some embodiments, the negative electrode layer or anode active layer comprises a lithium metal layer. This lithium metal layer may comprise a lithium foil, lithium particles, protected lithium particles, etc. This lithium metal layer may be absent when the bipolar electrode or the resultant bipolar lithium battery is made and prior to the first battery charge.

After the bipolar battery is charged, the primary surface at the anode side is deposited with a layer of lithium metal whose constituent lithium metal elements come from the cathode side.

In the disclosed polymer electrolyte, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The positive electrode (cathode) in the disclosed lithium cell typically comprises particles of a cathode active material and the electrolyte permeates into the cathode to come in physical contact with substantially all the cathode active material particles.

In certain desirable embodiments, in both the positive and the negative electrodes, the electrolyte further comprises particles of an inorganic solid electrolyte material having a particle size from 2 nm to 30 μm, wherein the particles of inorganic solid electrolyte material are dispersed in the polymer or chemically bonded by the polymer. The particles of inorganic solid electrolyte material are preferably selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

The bipolar lithium cell may be a lithium metal secondary battery (initially having a lithium metal layer or without a lithium metal layer when the battery is made), a lithium-ion battery, a lithium-sulfur battery, a lithium-ion sulfur battery, a lithium-selenium battery, or a lithium-air battery. A preferred embodiment of the present invention is a rechargeable lithium-sulfur battery or lithium-ion sulfur battery containing a sulfur cathode having sulfur or lithium polysulfide as a cathode active material.

For a lithium metal battery (wherein lithium metal is the primary active anode material), the current collector may comprise a metal foil (e.g., Al foil, Cu foal, stainless steel cell) having two primary surfaces wherein at least one primary surface is coated with a layer of graphene, or expanded graphite. One coated primary surface (the anode side) may be further coated with or protected by a layer of lithiophilic metal (a metal capable of forming a metal-Li solid solution or is wettable by lithium ions), a layer of graphene material, or both. The lithiophilic metal is preferably selected from Au, Ag, Mg, Zn, Ti, K, Al, Fe, Mn, Co, Ni, Sn, V, Cr, an alloy thereof, or a combination thereof.

For a lithium ion battery pack, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In some embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

The separator may comprise a polymer, inorganic, or composite solid electrolyte; it may simply comprise a porous polymer membrane. In certain embodiments, the separator comprises polymeric fibers, ceramic fibers, glass fibers, or a combination thereof. These fibers may be stacked together in such a manner that there are pores that allow for permeation of lithium ions, but not for penetration of any potentially formed lithium dendrites. These fibers may be dispersed in a matrix material or bonded by a binder material. This matrix or binder material may contain a ceramic or glass material. The polymer electrolyte herein disclosed may serve as the matrix material or binder material that helps to hold these fibers together. The separator may contain particles of a glass or ceramic material (e.g., metal oxide, metal carbide, metal nitride, metal boride, etc.).

These and other advantages and features of the present invention will become more transparent with the description of the following best mode practice and illustrative examples.

### BRIEF DESCRIPTION OF THE DRAWINGS

FIG. 1 Schematic of a bipolar lithium-ion battery according to some embodiments of the present disclosure.

FIG. 2(A) Schematic of a module (super-cell) comprising multiple bipolar electrodes and ion-permeating membrane layers (separators or solid-state electrolyte layers) internally connected in series according to some embodiments of the present disclosure;

FIG. 2(B) Schematic of a bipolar battery pack comprising a plurality of modules (each comprising internally series-connected bipolar electrodes along with ion-permeating layers); these modules are internally connected in parallel to form a pack according to some embodiments of the present disclosure;

FIG. 2(C) Schematic of a bipolar battery pack comprising a plurality of modules, internally connected in parallel and enclosed in a protective housing according to some embodiments of the present disclosure.

FIG. 3(A) Structure of a bipolar anode-less lithium metal battery (as manufactured or in a discharged state) according to some embodiments of the present disclosure;

FIG. 3(B) Structure of a bipolar anode-less lithium metal battery (in a charged state) according to some embodiments of the present disclosure.

FIG. 4(A) Schematic of a process for producing a bipolar electrode comprising a positive electrode (or cathode) layer deposited on a primary surface of a bipolar current collector and a negative electrode (or anode) layer deposited on the opposing primary surface of this current collector (or initially no anode layer is deposited) according to some embodiments of instant disclosure (e.g., using a powder gun or electrostatic spray coating means to deposit a solid mixture layer; the process being substantially liquid solvent-free);

FIG. 4(B) Schematic of another process for producing a bipolar electrode comprising a cathode layer deposited on a first primary surface of a bipolar current collector (e.g., a two-layer structure including an Al foil, to support the cathode layer, and a Cu foil, to support an anode layer) and an anode layer deposited on the opposing primary surface of this current collector, on the Cu foil side (or initially no anode layer is deposited) according to some embodiments of instant disclosure;

FIG. 5(A) Schematic of a process to produce a roll of bipolar electrode in a roll-to-roll or reel-to-reel manner according to some embodiments of the present disclosure; the diagram is used to illustrate, as an example, a process of electrostatically spraying (aerosolizing) a mixture of charged solid particles, which are deposited on a primary surface of a current collector at an electrostatic potential conducive to forming a local electric field to attract the solid particles oppositely charged;

FIG. 5(B) Schematic of a process to produce a roll of bipolar electrode in a roll-to-roll or reel-to-reel manner according to some embodiments of the present disclosure;

FIG. 5(C) Schematic of a process to produce a roll of bipolar electrode in a roll-to-roll or reel-to-reel manner according to some embodiments of the present disclosure;

### DETAILED DESCRIPTION

The present invention provides methods of producing a safe and high-performing lithium battery, which can be any of various types of lithium-ion or lithium metal batteries. A high degree of safety is imparted to this battery by a novel and unique electrolyte that is highly flame-resistant and would not initiate a fire or sustain a fire and, hence, would not pose explosion danger. This invention has solved the very most critical issue that has plagued the lithium-metal and lithium-ion industries for more than two decades. As indicated earlier in the Background section, a strong need exists for a safe, non-flammable solid-state electrolyte system for a rechargeable lithium battery, particularly a bipolar lithium battery system.

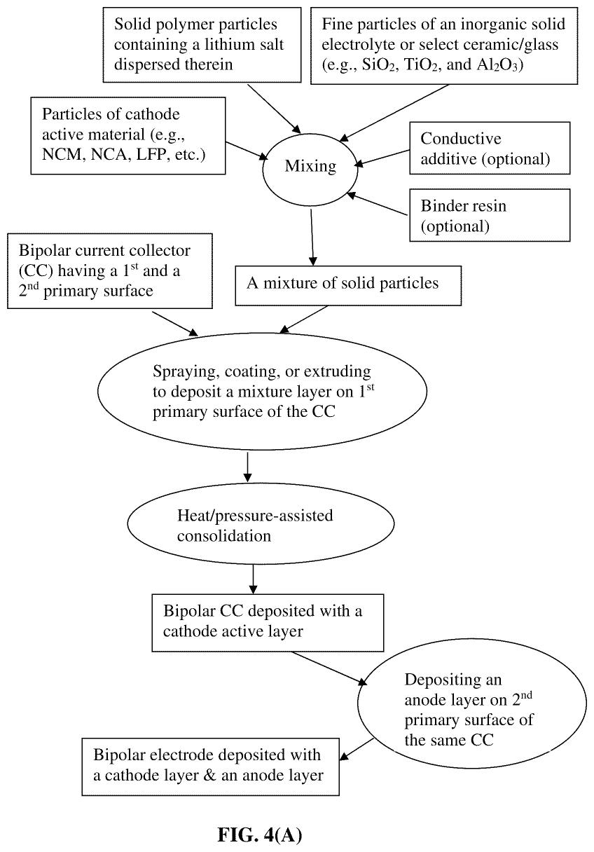

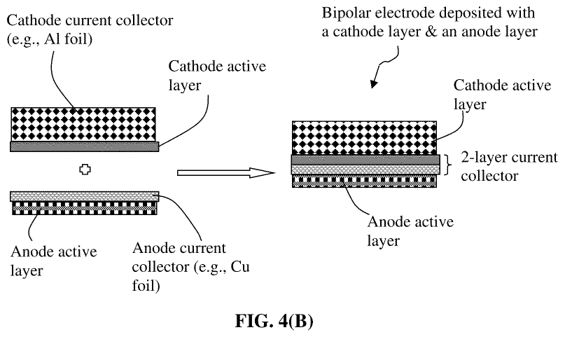

The present disclosure provides a method of producing a bipolar battery module or pack, as schematically illustrated in FIG. 4(A). The method comprises:
(a) providing a first set of multiple bipolar electrodes and at least one or multiple ion-permeable separator layers, wherein at least one bipolar electrode is prepared by (A) providing a current collector comprising a conductive material foil having a thickness from 10 nm to 100 μm and two opposing primary surfaces, herein referred to as a first primary surface and a second primary surface, respectively; (B) preparing a positive electrode (cathode) layer deposited on the first primary surface by (i) dispensing, spraying, coating, casting, or extruding to deposit a mixture of functional solid particles onto the first primary surface to form a mixture layer comprising solid particles of a cathode active material, an optional conductive additive, an optional binder resin, and a first polymer electrolyte having a lithium salt dispersed therein, which is a solid polymer or polymer composite electrolyte being substantially free from a liquid solvent and having a lithium ion conductivity no less than 1.0×10⁻⁸ S/cm at room temperature and (ii) optionally applying a pressure, heat, or both pressure and heat to consolidate said mixture layer to form the positive electrode layer; and (C) optionally depositing a negative electrode layer on the second primary surface wherein the negative electrode layer comprises a lithium metal layer or a layer of a mixture of solid particles of an anode active material, an optional conductive additive, an optional binder resin, a second polymer electrolyte having a lithium salt dispersed therein, which is different than or the same as the first electrolyte;
(b) stacking the bipolar electrodes and separator layers alternately to form a battery stack comprising bipolar cells internally connected in series;
(c) exerting a pressure along a stacking direction or a pressure and heat to the battery stack to form a bipolar module; and
(d) optionally encasing the module with a housing element to form a pack.

In this method, step (b) and step (c) may further comprise forming at least another module in a similar manner and connecting the resulting multiple modules in parallel, and step (c) comprises encasing the parallel-connected multiple modules with a protective housing element to form a pack.

We have discovered that it is possible to combine solid particle aerosolization and electrostatic powder deposition to deposit a mixture of multiple types (2 or more types) of solid particles onto a solid substrate (e.g., Cu foil, Al foil, graphene-coated Al or Cu foil, expanded graphite-coated Al or Cu foil, etc.). Quite surprisingly, we can aerosolize and electrostatically charge, separately or in a mixture form, various solid particles of cathode active materials (e.g., lithium iron phosphate, LFP, and lithium transition metal oxides, NCM or NCA, which are not very conductive), particles of polymer electrolytes (e.g., PEO, PVDF-HFP, polyvinylene carbonate, etc., which are highly insulating), particles of a resin binder (e.g., PVDF), fine ceramic/glass particles (e.g., nanometer- or micron-scaled SiO₂, TiO₂, and Al₂O₃, highly insulating), fine particles of inorganic solid electrolyte (e.g., garnet-type, sulfide-type, hydride type, halide type, borate type, phosphate type, lithium phosphorus oxynitride (LiPON), garnet-type, lithium superionic conductor (LISICON) type, and sodium superionic conductor (NASICON) type, all electrically insulating), and conductive additives (e.g., carbon black, CNTs, graphene sheets, all electrically conductive). The mixture of these aerosolized and charged particles (charged to different extents) can then be well-deposited on a solid substrate if the resin binder and/or solid polymer electrolyte are brought to a temperature close to their respective glass transition or melting temperatures (e.g., within 50 degrees Celsius, preferably within 20 degrees Celsius). Thus, these particles and/or the substrate should be preferably preheated. The deposited layer of particles is then quickly consolidated via roll-pressing with heated rollers.

The solid substrate is typically electrically grounded or made to have the opposite charge relative to the solid particles. The two primary surfaces of a bipolar current collector are deposited with a cathode layer and an anode layer, respectively; the two cannot be deposited with the same type of active layers (e.g., both surfaces deposited with a cathode layer), in contrast to the situation of a conventional lithium-ion cell wherein both surfaces of a Cu foil are deposited with an anode active layer and both surfaces of an Al foil are deposited with a cathode active layer.

In certain embodiments, the pressure in step (c) is from 0.1 to 1,000 psi, the temperature is from 25° C. to 400° C., and the period of time is from 10 seconds to 5 hours. The temperature needed depends upon the proper glass transition or melting point of the polymer. The magnitude of the pressure applied to the stack/module or pack depends upon the type of polymer electrolyte used. We have observed that the application of a pressure on the bipolar stack or module can significantly reduce the internal impedance or resistance of a battery module. The internal resistance of the entire bipolar pack, comprising multiple bipolar modules connected in parallel, is also reduced, enabling significantly improved power density. This pressure can be exerted onto modules, along the module stacking direction (e.g., perpendicular to the bipolar plane), using means such as roll-pressing, hydraulic power driven compressing press, and hydrostatic pressing.

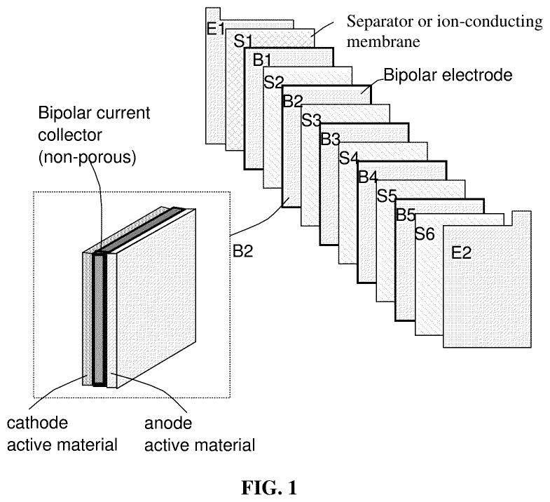

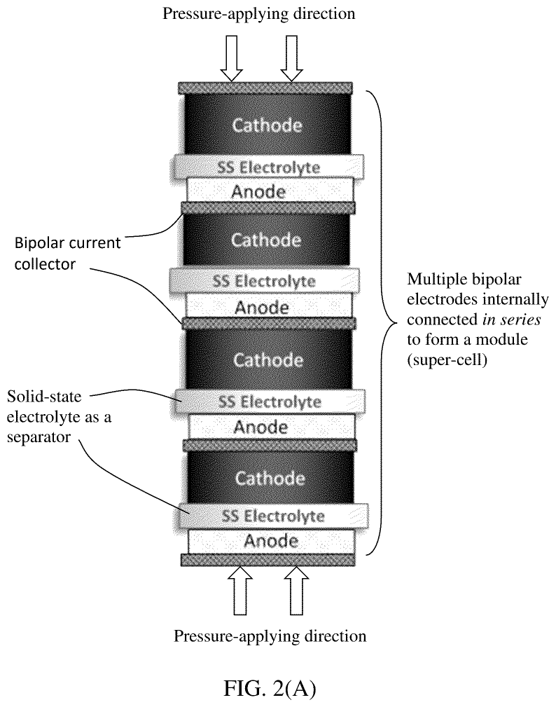

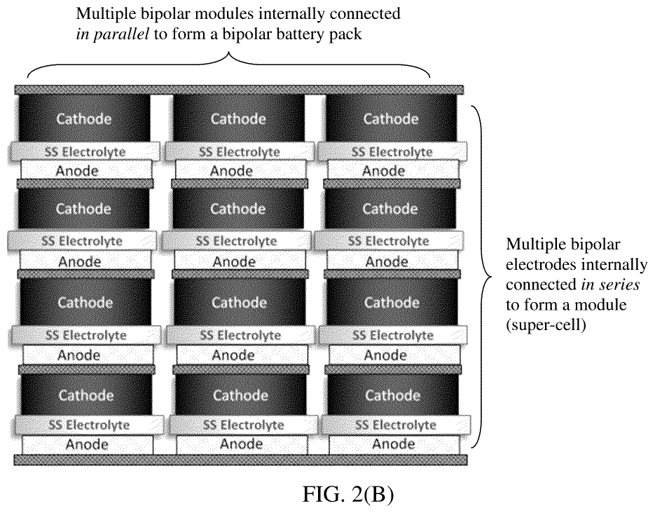

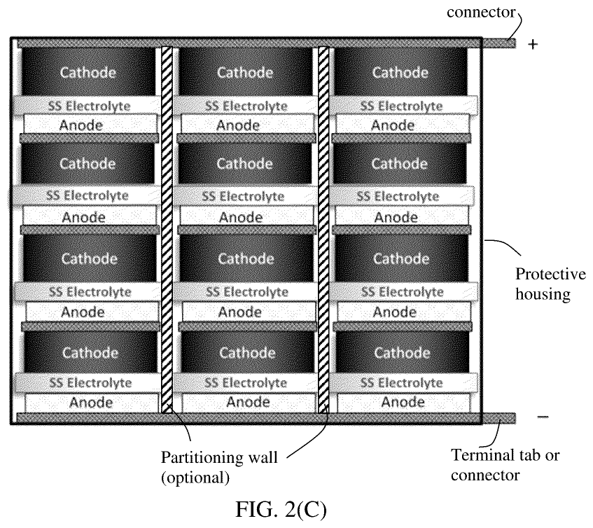

The bipolar battery pack may comprise a module or a plurality of modules wherein each module is a stack of multiple bipolar electrodes separated by a lithium-ion permeable membrane (separator, or a solid-state electrolyte) between two bipolar electrodes that are internally connected in series. The resulting module comprises multiple unit cells, each cell comprising an anode layer (coated on a bipolar current collector), a separator, and a cathode layer (coated on neighboring current collector). As illustrated in FIG. 1 as one example, the internal series connection (ISC) technology involves combining a desired number of bipolar electrodes (e.g., B1-B5), separated from one another by an ion-permeable separator (e.g., S1-S6), and cladded by two terminal electrodes (E1 and E2). In this configuration, only these two terminal electrodes are externally connected to the outside circuit and all the intermediate bipolar electrodes are isolated from the outside circuit. Series connection provides a high voltage output (high V), which is the sum of the voltage values of all cells: for instance, if one cell giving 3.7 volts (e.g., for a graphite-LiCo₂ cell), then two cells giving 7.4 volts, and n cells giving 3.7 n volts, etc. The number n can be any integer that is 2 or greater than 2 (for practical purposes, n is from 2 to 1,000). This is further illustrated in FIG. 2(A).

FIG. 1 provides but one example of the many possible combinations for high-voltage stacks. The five intermediate electrodes (B1-B5) are bipolar electrodes, each composed of a non-porous conductive metal foil having one primary surface coated with an anode active material layer and the opposing primary surface coated with a cathode active material layer. The separator S1 is inserted between terminal electrode E1 and the first bipolar electrode B1 and the separator S2 is inserted between bipolar electrode B1 and bipolar electrode B2, etc. Such a configuration implies that each separator is sandwiched between an anode layer of a bipolar electrode and a cathode layer of a neighboring bipolar electrode to form a unit cell. For instance, S2 is sandwiched between the anode layer coated on B1 and the cathode layer coated on B2 to form a unit cell, and S3 is sandwiched between the anode layer coated on B2 and the cathode layer coated on B3 to form another unit cell. These two unit cells are naturally connected in-series through the metal foil at B2, without using an external wire and terminal and, thereby, reducing the weight, volume, and electrical resistance of a lithium battery stack.

During a charging step, lithium ions come out of the cathode active material layer and travels through a separator into an anode active material layer, which belongs to the same unit cell but supported by a different bipolar current collector. During a subsequent discharge step, lithium ions travel in the opposite direction. These lithium ions are confined in a unit cell, and not to be allowed to stray into a neighboring cell. This condition can be met if the electrolyte is a solid-state electrolyte and the current collector is made out of an electrically conductive material that is not permeable to lithium ions. The graphene or expanded graphite (or exfoliated graphite worm) coating makes the metal foil non-permeable to lithium ions.

The number of unit cells in a stack depends upon the needed output voltage of the stack. Using a unit cell voltage of 3.7 volts as a basis, a lithium-ion battery stack for use in an electric power scooter (48V), for instance, will require 13 unit cells connected in series. Such a stack constitutes a lithium-ion battery “element” which, if inserted into a casing and fitted with a PC board (control electronics), makes a great power module.

As schematically illustrated in FIG. 2(B), multiple modules, each composed of internally series-connected bipolar plates, may be internally connected in parallel to form a bipolar battery pack to increase the battery capacity (Amp-hours, or Ah). As illustrated in FIG. 2(C), the bipolar battery pack is preferably protected by a protective housing, allowing at least two terminals protruded out of the housing unit for connecting to outside circuit.

In certain embodiments, one or both of the primary surfaces of the conductive material foil (e.g., Al foil, Cu foil, stainless steel cell, etc.) is coated with a layer of graphene or expanded graphite sheets having a layer thickness from 1 nm to 50 μm. This could prevent lithium diffusion in the metal foil, which otherwise could degrade the function of a bipolar electrode

Alternatively, this conductive foil contains a laminate of two or more conductive materials laminated together. For instance, this can contain a layer of Cu (for supporting the negative electrode layer) and a layer of Al (for supporting the positive electrode layer) that are mechanically compressed or chemically bonded together. This can also be a Cu foil or Al foil coated with a layer of conductive polymer (e.g., an intrinsically conductive polymer or a polymer matrix containing conductive fillers dispersed therein; examples of conductive fillers being graphene sheets, carbon nanotubes, carbon fibers, carbon black particles, etc.).

Since the bipolar current collector can be a laminate of 2 or 3 conductive material films or foils mechanically or chemically bonded together face-to-face, the disclosure also provides a method of producing a bipolar battery pack, as schematically illustrated in FIG. 4(B), the method comprising:
(a) Providing a first set of multiple bipolar electrodes and at least one or multiple ion-permeable separator layers, wherein at least one bipolar electrode is prepared by (A) providing a first current collector comprising a first conductive material foil having a thickness from 10 nm to 100 μm and two opposing primary surfaces, herein referred to as a first primary surface and a second primary surface, respectively; (B) preparing a positive electrode layer disposed on the first primary surface to form a first half of the bipolar electrode, which is conducted by (i) spraying, coating, casting, or extruding to deposit a mixture of functional solid particles onto the first primary surface to form a mixture layer comprising solid particles of a cathode active material, an optional conductive additive, an optional binder resin, and a first polymer electrolyte having a lithium salt dispersed therein, which is a solid polymer electrolyte being substantially free from a liquid solvent and having a lithium ion conductivity no less than 1.0×10⁻⁸ S/cm at room temperature and wherein the second surface is not deposited with a positive electrode layer or negative electrode layer; and (ii) optionally applying a pressure, heat, or both pressure and heat to consolidate said mixture layer to form said positive electrode layer; (C) providing a second current collector comprising a second conductive material foil, different than the first conductive material, having a thickness from 10 nm to 100 μm and two opposing primary surfaces, hereinafter referred to as the third primary surface and the fourth primary surface, respectively; and (D) either depositing a negative electrode layer on the third primary surface (or initially having no negative electrode layer deposited on the third primary surface) to obtain a second half of the bipolar electrode, wherein the negative electrode layer, if present, comprises (i) a lithium metal layer and/or (ii) a layer of a mixture of particles of an anode active material, an optional conductive additive, an optional binder resin, and a second polymer electrolyte comprising a lithium salt dispersed therein, and wherein the fourth surface is not deposited with a positive electrode layer or a negative electrode layer; and (E) combining the first half of the bipolar electrode and the second half of the bipolar electrode to form the bipolar electrode wherein the second primary surface and the fourth primary surface are mechanically compressed or chemically bonded back-to-back together;
(b) stacking the multiple bipolar electrodes alternately with the layers of ion-permeable separator for connecting multiple bipolar electrodes in series to form a stack in such a manner that a layer of ion-permeable separator is disposed between the negative electrode layer of a bipolar electrode and the positive electrode layer of a neighboring bipolar electrode;
(c) applying a pressure, heat, or both pressure and heat to the stack for a desired period of time to consolidate the stack for forming a battery module; and
(d) optionally encasing the module(s) with a housing element to form a pack.
   In certain embodiments, step (b) and step (c) further comprise forming at least another module in a similar manner and connecting the resulting multiple modules in parallel, and step c) comprises encasing the parallel-connected multiple modules with a protective housing element to form a pack.

The presently disclosed methods are capable of producing a broad array of bipolar lithium battery modules and packs. As an example, the disclosure provides a bipolar battery pack comprising one or a plurality of modules wherein at least one module comprises a first set of multiple bipolar electrodes internally connected in series, wherein at least one of the bipolar electrodes comprises:
A) A current collector comprising a conductive material foil having a thickness from 10 nm to 100 μm and two opposing primary surfaces;
B) a positive electrode (cathode) layer disposed on one of the two primary surfaces (also herein referred to as a first primary surface), wherein the positive electrode (cathode) layer comprises a mixture of particles of a cathode active material, an optional but typically desired conductive additive, an optional binder resin, and a first polymer or polymer hybrid/composite electrolyte comprising a mixture of an inorganic solid-state electrolyte and a solid polymer electrolyte, wherein the solid polymer comprises a lithium salt dispersed in the polymer having a polymer-to-lithium salt weight ratio of from 1/100 to 100/1 and the polymer has a lithium ion conductivity no less than 1.0×10⁻⁸ S/cm and; and
C) either (i) a negative electrode layer deposited on the opposing primary surface (also herein referred to as the second primary surface) wherein the negative electrode layer comprises a lithium metal layer or a mixture of particles of an anode active material, a solid polymer electrolyte, and, optionally, particles of a solid inorganic solid-state electrolyte wherein the solid polymer comprises a lithium salt dispersed therein with a polymer-to-lithium salt weight ratio of from 1/100 to 100/1 or (ii) initially without a negative electrode layer deposited on said opposing primary surface (so-called “anodeless”) when the battery pack is made (a lithium metal layer is formed when the battery pack is charged);
   wherein the multiple bipolar electrodes are connected in series in such a manner that an ion-permeable separator or solid-state electrolyte layer is disposed between the negative electrode layer of a bipolar electrode and the positive electrode layer of a neighboring bipolar electrode and in close contact with this negative electrode layer and this positive electrode layer.

The bipolar battery pack may comprise multiple sets (modules) of multiple bipolar electrodes internally connected in series and these multiple sets (modules) of multiple bipolar electrodes are internally connected in parallel. Preferably, the bipolar battery pack further comprises a protecting housing that encloses the multiple modules.

In some preferred embodiments, the solid polymer electrolyte and the inorganic solid-state electrolyte, in combination, form a contiguous phase in the cathode, in the anode, or in both the anode and the cathode, and the contiguous phase is in a physical contact or ionic communication with the ion-permeable separator or solid-state electrolyte layer. This would ensure uninterrupted flow of lithium ions from the cathode, through the separator (or solid-state electrolyte), into the anode during the battery charge, as well as flow from the anode through the separator and into the cathode (throughout the entire cathode).

The current collector may comprise a metal foil (e.g., Al foil, Cu foil, stainless steel cell, etc.), a conducting polymer or polymer composite layer, a graphite layer (expanded graphite or recompressed graphite worm) layer, or graphene layer. The current collector has two primary surfaces wherein preferably at least one primary surface is coated with a protective layer of graphene or expanded graphite to prevent lithium diffusion in the metal foil, which otherwise could defeat the purpose of a bipolar electrode. This protective graphene/graphite coating layer mat contain just the graphene, expanded graphite flakes, and/or recompressed exfoliated graphite worms or a composite layer comprising graphene sheets, expanded graphite flakes, and/or recompressed exfoliated graphite worms that are dispersed in or bonded by a matrix or binder material. The bonder/matrix material may be selected from a polymer, glass, ceramic, or carbon material.

Alternatively, this conductive foil contains a laminate of two or more conductive materials laminated together. For instance, this can contain a layer of Cu (for supporting the negative electrode layer) and a layer of Al (for supporting the positive electrode layer) that are mechanically compressed or chemically bonded together. This can also be a Cu foil or Al foil coated with a layer of conductive polymer (e.g., an intrinsically conductive polymer or a polymer matrix containing conductive fillers dispersed therein; examples of conductive fillers being graphene sheets, carbon nanotubes, carbon fibers, carbon black particles, etc.).

In the bipolar pack, the solid polymer electrolyte preferably comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

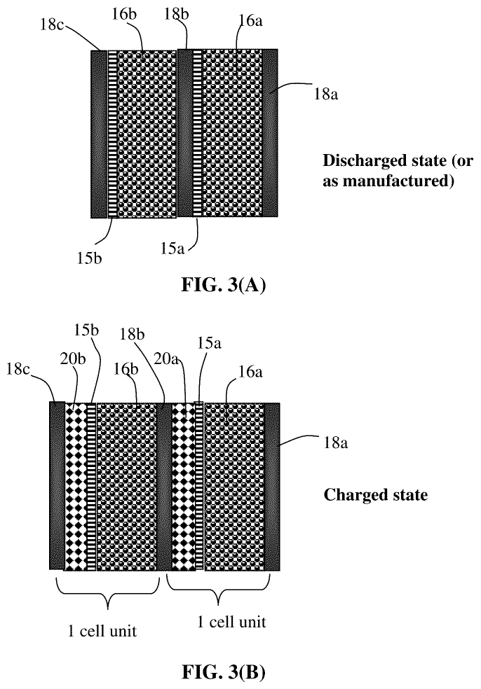

In a special battery configuration, a primary surface of the bipolar current collector is deposited with a cathode active material layer containing particles of a cathode active material (e.g., LiCoO₂, LiMn₂O₄, etc.) having available Li atoms in the structure; but the opposing primary surface is not deposited with any anode material (as schematically illustrated in FIG. 3(A)) or is deposited with a lithium metal-protecting layer only (such as an elastic polymer or a graphene ball layer) but no lithium metal or other anode active material when the bipolar electrode or the bipolar battery is made (prior to the first charge step). Such a bipolar lithium battery is herein referred to as an “anode-less” bipolar lithium metal battery. During the discharge step, lithium ions come out of the cathode material structure, traverse a separator, and move to the anode side where the lithium ions deposit onto the opposing primary surface of the current collector to form a lithium metal layer. This is illustrated in FIG. 3(B).

The presently invented internal series connection (ISC) and internal parallel connection (IPC) bipolar battery technology has the following features:
(1) The stack perimeter should be properly sealed to ensure that each and every constituent cell is isolated from one another; this is readily achievable with a solid-state electrolyte herein disclosed. In addition, none of the bipolar current collectors can be porous; they have to be absolutely impermeable to electrolyte. This is achieved by using a solid metal foil which is preferably further protected by a graphene or expanded graphite layer. The electrolyte from one unit cell is not allowed to enter another unit cell; there is no fluid communication between two cells.
(2) Any output voltage (V) and capacity value (Ah) can be tailor-made by selecting a proper number of unit cells and the lateral dimensions and thickness of the anode layer and the cathode layer of a unit cell; any practical voltage can be easily obtained. The capacity value of a pack can be increased by increasing the number of modules connected in parallel.
(3) During re-charge, each constituent cell in a multi-cell battery stack can adjust itself to attain voltage distribution equilibrium, removing the need for the high-voltage stack to have a protective circuit.
(4) The ISC and IPC technology enables significant savings in materials, volume and weight of cell-to-cell connectors and elimination of most welds necessary for the conventional modules/packs.
(5) As such, much higher energy density, higher specific energy, and higher power density can be achieved at lower costs.
(6) With multiple cells electrically connected in series naturally, one can produce a high-voltage “super-cell” having an output voltage from 6.4 volts to 800+ volts (no theoretical upper limit) with minimal connector weights, volumes, and costs.

In the conventional lithium-ion battery or lithium metal battery industry, a liquid solvent is used to dissolve a lithium salt therein and the resulting solution is used as a liquid electrolyte. The commonly used liquid solvents have a relatively high dielectric constant and, hence, are capable of dissolving a high amount of a lithium salt. However, they are typically highly volatile, having a low flash point and being highly flammable. In the presently disclosed bipolar electrodes, the cathode (positive electrode) layer and the anode (negative electrode) layer contain substantially solid-state electrolytes produced by several approaches.

In the disclosed polymer electrolyte, the lithium salt dispersed or dissolved in the polymer may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴+ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

These inorganic solid electrolyte (ISE) particles encapsulated by an elastic electrolyte polymer shell can help enhance the lithium ion conductivity of certain polymers that have a lower ion conductivity than the encapsulated ISE. Preferably and typically, the elastic polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by encapsulating the ISE particles with a polymer electrolyte that typically has a significantly wider electrochemical stability window (e.g., can be from 0 to 4.5 V relative to Li/Li⁺). The polymer protection also enables the ISEs processible using the current lithium-ion cell production processes.

These solid electrolyte particles dispersed in an electrolyte polymer can help enhance the lithium ion conductivity of certain polymers having an intrinsically low ion conductivity.

Preferably and typically, the polymer has a lithium ion conductivity no less than 10⁻⁵ S/cm, more preferably no less than 10⁻⁴ S/cm, and further preferably no less than 10⁻³ S/cm.

The disclosed dipolar lithium battery can be a lithium-ion battery or a lithium metal battery, the latter having lithium metal as the primary anode active material. The lithium metal battery can have lithium metal implemented at the anode when the battery is made. Alternatively, the lithium may be stored in the cathode active material and the anode side is lithium metal-free initially. This is called an anode-less lithium metal battery.

As illustrated in FIG. 3(A), the bipolar anode-less lithium battery is in an as-manufactured or fully discharged state according to certain embodiments of the present disclosure. The battery comprises multiple cells, wherein a cell comprises a separator (e.g., 15a, 15b), a cathode layer (e.g., 16a, 16b) supported on a bipolar current collector (e.g., 18a, 18b), and a neighboring bipolar current collector (e.g., 18b, 18c) having one primary surface (the anode side) initially being free from any lithium metal. Each cathode layer comprises a cathode active material, a conductive additive (not shown), an optional resin binder (not shown), and an electrolyte (dispersed in the entire cathode layer and in contact with the cathode active material). The bipolar current collector (18a, 18b, 18c) supports the cathode layer (16a, 16b) on a primary surface with the opposing primary surface being tentatively free from a lithium metal layer (as manufactured or in a fully discharged state). There is no lithium metal in the anode side of a bipolar current collector when the battery is manufactured.

In a charged state, as illustrated in FIG. 3(B), the battery cell comprises a lithium metal (20a, 20b) plated on the opposing primary surface (the anode side) of a bipolar current collector (18b, 18c), a separator (15a, 15b), and a cathode layer (16a, 16b). The lithium metal comes from the cathode active material (e.g., LiCoO₂ and LiMn₂O₄) that contains Li element when the cathode is made. During a charging step, lithium ions are released from the cathode active material and move to the anode side to deposit onto a primary surface of a bipolar current collector for forming a lithium metal layer, the anode active material.

One unique feature of the presently disclosed bipolar anode-less lithium battery is the notion that there is substantially no anode active material and no lithium metal is present when the battery is made. The commonly used anode active material, such as an intercalation type anode material (e.g., graphite, carbon particles, Si, SiO, Sn, SnO₂, Ge, etc.), P, or any conversion-type anode material, is not included in the battery. The anode only contains a current collector or a protected current collector. No lithium metal (e.g., Li particle, surface-stabilized Li particle, Li foil, Li chip, etc.) is present in the anode when the battery is made; lithium is basically stored in the cathode (e.g., Li element in LiCoO₂, LiMn₂O₄, lithium iron phosphate, lithium polysulfides, lithium polyselenides, NCA, NCM, etc.). During the first charge procedure after the battery is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on the surface of a bipolar current collector. During a subsequent discharge procedure, lithium ions leave this surface and travel back to the cathode, intercalating or inserting into the cathode active material.

Such an anode-less bipolar battery is much simpler and more cost-effective to produce as compared to the conventional lithium-ion battery since there is no need to have a layer of anode active material (e.g., graphite particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40-200 μm thick), the weight and volume of the cell can be significantly reduced, thereby increasing the gravimetric and volumetric energy density of the battery. This advantage is in addition to the advantage that there are substantially no connecting wires or cables between two unit cells, further saving the weight, volume, and cost.

Another important advantage of the anode-less battery is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal battery. The manufacturing facilities should be equipped with special class of dry rooms, which are expensive and significantly increase the battery cell costs.

The primary surface at the anode side of a bipolar current collector may be deposited with multiple particles or coating of a lithium-attracting metal (lithiophilic metal), wherein the lithium-attracting metal, preferably having a diameter or thickness from 1 nm to 10 μm, is selected from Au, Ag, Mg, Zn, Ti, K, Al, Fe, Mn, Co, Ni, Sn, V, Cr, an alloy thereof, or a combination thereof. This deposited metal layer may be further deposited with a layer of protective polymer that covers and protects the multiple particles or coating of the lithiophilic metal. Alternatively, the lithiophilic metal may be protected by a graphene layer that comprises graphene balls and/or graphene foam. Preferably, the graphene layer has a thickness from 1 nm to 50 μm and/or has a specific surface area from 5 to 1000 m²/g (more preferably from 10 to 500 m²/g). It may be noted that this protective graphene layer (for protecting the lithiophilic metal) is separate and different from the graphene or expanded graphite layer that is directly deposited onto the primary surfaces of a bipolar current collector to prevent diffusion of lithium ions through the metal foil; this graphene layer is further discussed below:

A bipolar current collector may be coated with a graphene or expanded graphite layer on one primary surface or both primary surfaces to protect against diffusion of lithium ions into the current collector (e.g., a metal foil). This graphene layer may comprise a graphene layer produced via chemical vapor deposition (CVD). The graphene layer may comprise graphene sheets selected from single-layer or few-layer graphene, wherein the few-layer graphene sheets are commonly defined to have 2-10 layers of stacked graphene planes having an inter-plane spacing d₀₀₂ from 0.3354 nm to 0.6 nm as measured by X-ray diffraction. The single-layer or few-layer graphene sheets may contain a pristine graphene material having essentially zero % of non-carbon elements, or a non-pristine graphene material having 0.001% to 45% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

For a bipolar lithium-ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In addition to the non-flammability and high lithium ion transference numbers, there are several additional benefits associated with using the presently disclosed solid-state electrolytes. As one example, these electrolytes can significantly enhance cycling and safety performance of rechargeable lithium batteries through effective suppression of lithium dendrite growth. Due to a good contact between the electrolyte and an electrode, the interfacial impedance can be significantly reduced.

As another benefit example, this electrolyte is capable of inhibiting lithium polysulfide dissolution at the cathode and migration to the anode of a Li—S cell, thus overcoming the polysulfide shuttle phenomenon and allowing the cell capacity not to decay significantly with time. Consequently, a coulombic efficiency nearing 100% along with long cycle life can be achieved.

There is also no restriction on the type of the cathode materials that can be used in practicing the present disclosure. For Li—S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are no particular restrictions on the types of cathode active materials that can be used in the presently disclosed lithium battery, which can be a primary battery or a secondary battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li element therein, there should be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials comprise lithium nickel manganese oxide (LiNiₐMn₂₋ₐO₄, 0<a<2), lithium nickel manganese cobalt oxide (NCM or LiNiₙMnₘCo₁₋ₙ₋ₘO₂, 0<n<1, 0<m<1, n+m<1), lithium nickel cobalt aluminum oxide (NCA or LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In a preferred lithium metal secondary battery, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li element therein, there should be a lithium source implemented in the cathode side to begin with.

In another preferred bipolar rechargeable lithium battery (e.g. a lithium metal secondary battery or a lithium-ion battery), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆” type structure, oxocarbons), Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer may be selected from Poly[methanetetryl-tetra(thiomethylene)] (PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that include conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene] (PTKPTB) have a polyphenylene main chain, linking thiolane on benzene moieties as pendants. Similarly, poly[3,4(ethylenedithio)thiophene] (PEDTT) has polythiophene backbone, linking cyclo-thiolane on the 3,4-position of the thiophene ring.

In yet another preferred bipolar rechargeable lithium battery, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries has a high capacity and high energy density. Again, for those cathode active materials containing no Li element therein, there should be a lithium source implemented in the cathode side to begin with.

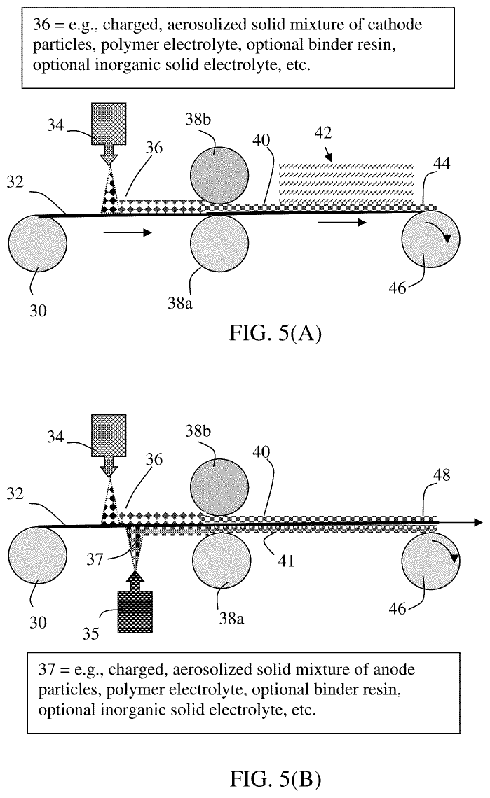

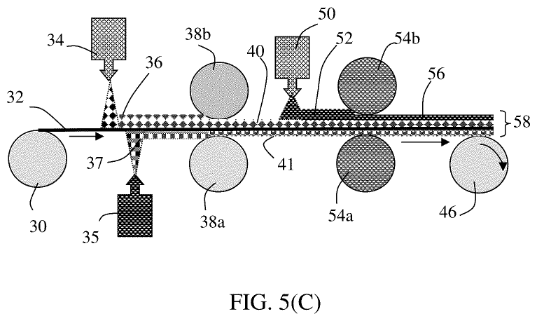

The present disclosure also provides a method of producing the disclosed bipolar electrode and bipolar battery pack, as illustrated in FIGS. 4(A), 4(B), 5(A), 5(B), and 5(C).

FIG. 5(A) is used as an example to illustrate a process of electrostatically spraying (aerosolizing and charge implementation) a mixture of charged solid particles, which are deposited on a primary surface of a current collector at an electrostatic potential conducive to forming a local electric field to attract the solid particles oppositely charged. Surprisingly, electrostatic spraying is found to be a highly effective process of depositing a powder mixture of multiple materials onto a solid substrate surface.

The roll-to-roll process may begin with continuously feeding a solid substrate layer 32 (e.g., graphene- or expanded graphite-coated Al foil, which is electrically grounded) from a feeder roller 30. A dispensing and depositing device 34 (e.g., an electrostatic sprayer or corona gun) is operated to dispense and deposit a solid powder mixture layer 36 (e.g., a layer of mixtures comprising cathode active material particles, solid polymer electrolyte particles, an optional resin binder, optional particles of a ceramic or glass material or inorganic solid electrolyte, optional conductive filler particles or fibers) onto the solid substrate layer 32, which is driven toward a pair of heated rollers (38a, 38b). These rollers are an example of a provision to regulate the thickness and consolidate the mixture layer 40. The consolidated cathode layer 40, supported on the solid substrate, is driven to move through an optional heating zone 42 which is provided with a heating means (heat, IR, etc.) to help further consolidate (heating and then cooling, as needed) the cathode active layer. The consolidated cathode active later 44, coated on a current collector 32, is collected on a winding roller 46.

The negative electrode (anode) can be produced in a similar manner, similar to those processes described in FIG. 5(A). An anode layer may be deposited before, during or after the cathode layer is deposited or consolidated so that the anode layer, according to certain embodiments of the present disclosure, as illustrated in FIG. 5(B). The anode layer may be just a layer of lithium metal or a lithium metal-protecting polymer that can be deposited using vapor deposition, sputtering, spraying, etc. Alternatively, the anode layer may be a mixture layer 37 of solid particles of an anode active material, a solid polymer electrolyte, an optional resin binder, an optional inorganic solid-state electrolyte or ceramic/glass material, etc. This mixture layer 37 of solid particles may be dispensed from an electrostatic sprayer 35. The mixture layer 37 is driven toward a pair of heated rollers (38a, 38b) to consolidate and form the consolidated mixture layer 41. The three-layer structure 48 (cathode layer+current collector+anode layer) is then collected on a winding roller 46.

One may unwind the roll at a later stage. The process may further comprise cutting and trimming the continuous layer of bipolar electrode into one or multiple pieces of bipolar electrodes. The process may further comprise combining multiple bipolar electrodes and separators into a bipolar lithium battery modules and pack. Preferably, a pressure is applied on a bipolar module or a pack during the manufacturing process.

In some preferred embodiments, a solid-state polymer or polymer composite electrolyte layer may be deposited on the surface of a cathode layer or an anode layer, As an example, schematically illustrated in FIG. 5(C), continued from FIG. 5(A) or (B), a solid mixture layer 52 is sprayed from a dispensing device 50 (e.g., an electrostatic sprayer) and is driven to move toward a pair of heated rollers (54a and 54b) to consolidate and form a solid-electrolyte separator layer 56 on the surface of a cathode layer 40. The resulting 4-layer structure 58 (a solid-state electrolyte separator 56+a cathode active layer 40+a bipolar current collector 32+an anode active layer 41) is then collected on the winding roller 46.

FIGS. 5(A), 5(B) and 5 (C) show that step a) and/or step b) comprises depositing a positive electrode layer, a negative electrode layer, and/or an ion-permeable separator layer in a reel-to-reel or roll-to-roll manner. It is highly advantageous to prepare a bipolar electrode in a reel-to-reel or roll-to-roll manner in terms of process automation, high production rate, and low cost.

It may be noted that electrostatically spraying solid powder is only one of the several ways of dispensing and depositing a mixture of solid powders on a substrate. For instance, one may use an automated powder dispenser to dispense and spread powder mixture on a solid substrate (a bipolar current collector). The powder mixture may comprise particles of a cathode active material (e.g., carbon-coated LFP particles, 20 nm-20 μm in diameter), polymer electrolyte particles (comprising lithium salt and inorganic solid electrolyte particles dispersed therein), graphene sheets and/or carbon nanotubes (CNTs) as a conductive additive, and an optional (not required) binder resin (e.g., PVDF). The mixture may be immediately heated to above the glass transition temperature (if an amorphous polymer) or melting point (if a crystalline polymer) of the polymer electrolyte. The layer of powder mixture comprising a molten or softened polymer electrolyte can then be consolidated using roll-pressing (e.g., with a pair of heated rollers). Additional examples of electrode deposition procedure are extrusion and tape casting or coating. Other powder dispensing methods, not involving imparting charges to the powder mixture to be dispensed, are advantageous in terms of equipment simplicity and lower costs.

Thus, in certain embodiments, the method comprises at least one of the following procedures: (i) depositing the positive electrode layer by dispensing or spraying a mixture of solid particles onto the first primary surface to form a mixture layer wherein the step of dispensing or spraying comprises metering and dispensing the mixture of solid particles to form a solid powder mixture layer having a thickness from 0.1 μm to 2,000 μm on the first primary surface with or without imparting charges to the solid powder mixture; (ii) depositing the negative electrode layer by dispensing or spraying a mixture of solid particles onto the second primary surface to form a mixture layer wherein the step of dispensing or spraying comprises metering and dispensing the mixture of solid particles to form a solid powder mixture layer having a thickness from 0.1 μm to 2,000 μm on the second primary surface with or without imparting charges to the solid powder mixture, which comprises the mixture of solid particles of an anode active material, an optional conductive additive, an optional binder resin, a second polymer electrolyte having a lithium salt dispersed therein; and (iii) depositing an ion-permeable separator layer by dispensing, onto a solid substrate surface, a solid powder mixture layer (preferably having a thickness from 0.05 μm to 500 μm) comprising a polymer and solid particles of an inorganic solid electrolyte and/or solid particles of a ceramic or glass material, wherein the solid substrate surface is a surface of a positive electrode layer, a negative electrode layer, or an ion-permeating membrane and wherein the dispensing procedure is conducted with or without imparting charges to the solid powder mixture.

In summary, the present disclosure provides a solvent-free method of producing a bipolar battery module, the method comprising (a) preparing multiple bipolar electrodes and one or multiple ion-permeating separators, wherein each bipolar electrode comprises a cathode active layer and an optional anode active layer and wherein at least one of the cathode active layer, the anode active layer and the separator comprises a polymer electrolyte or a polymer composite electrolyte, having a lithium salt and, optionally, particles of an ion-conducting inorganic material dispersed in a polymer matrix, wherein the polymer electrolyte or polymer composite electrolyte has a lithium ion conductivity no less than 10⁻⁶ S/cm; (b) stacking the bipolar electrodes and separator layers alternately to form a battery stack comprising bipolar cells internally connected in series; (c) exerting a pressure along a stacking direction or a pressure and heat to the battery stack to form a bipolar module; and (d) optionally encasing the module with a housing element to form a pack. In this method, step (b) and step (c) may further comprise forming at least another module in a similar manner and connecting the resulting multiple modules in parallel, and step (c) comprises encasing the parallel-connected multiple modules with a protective housing element to form a pack.

The following examples are presented primarily for the purpose of illustrating the best mode practice of the present invention, not to be construed as limiting the scope of the present invention. In the present study, the conductive additive in the electrodes was typically selected from carbon black or acetylene black (e.g., Super-P), carbon nanotubes (CNTs), or graphene sheets, unless otherwise specified.

### EXAMPLE 1

### Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### EXAMPLE 2

### Preparation of Solid Electrolyte Powder, Lithium Superionic Conductors With the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000°C for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### EXAMPLE 3

### Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J.L.M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### EXAMPLE 4

### Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed includes two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### EXAMPLE 5

### Preparation of Halide Solid Electrolytes

As an example, the halide solid electrolytes were prepared by ball milling and subsequent solid-state reactions. Raw materials of LiCl (99.9%), InCl₃ (99.99%), ScCl₃ (99.99%,), YCl₃ (99.99%), YbCl₃ (99.99%), LuCl₃ (99.99%) and ZrCl₄ (99.9%) were used as starting materials. The stoichiometric starting materials were weighed and sealed in a ZrO₂ jar along with 18 ZrO₂ balls and the mixture was ball milled at 350 rpm for 12 hours in an Ar-filled glovebox with p(H₂O)/p<0.1 ppm, p(O₂)/p<0.1 ppm. During ball milling, the jar was periodically opened to make the samples homogenous at each 5 h interval in a glovebox. Subsequently, the resulting mixture was sealed in quartz tubes and annealed at 260° C. for 12 h with a heating rate of 2° C. min⁻¹ and then cooled naturally to room temperature. Then, the obtained material was stored in an Ar-filled glovebox to prevent any moisture exposure.

### EXAMPLE 6

### Electrostatic Spraying and Static Charge-Free Spraying of Solid Particles for Electrode Layers, Solid-State Electrolyte Separator Layers, Bipolar Electrodes, and Combined Separator/Cathode Layers

As an example of the process, a mixture of carbon-coated LFP particles, particles of PVDF-HFP polymer electrolyte, and CNTs, at a 90:5:5 mass ratio, was deposited on a graphene-coated aluminum foil substrate. Particles of PVDF-HFP polymer electrolyte were prepared by dissolving PVDF-HFP and a lithium salt, lithium hexafluorophosphate (LiPF₆) or lithium borofluoride (LiBF₄), in a solvent (a mixture of DMSO and acetone at an 1/1 volume ratio) to make a solution, which was spray-dried to form particles of PVDF-HFP having a lithium salt dispersed therein. The mixture was placed in a 5 lb fluidized bed hopper and fluidized using a vibrating element attached to the hopper. A Venturi pump was used to deliver the fluidized powder from the hopper to a corona gun set at a voltage of 50 kV and positioned 1.5 inches away from the foil substrate. The foil was heated convectively using a heat gun such that the front side of the foil was measured to exceed 200° C. above the melting point of PVDF-HFP. The heated solid powder mixture was then consolidated using a pair of pressing rolls and cooled to form a cathode layer. The opposing primary surface of the graphene-coated Al foil was then deposited with a graphite-based anode layer to make a bipolar electrode.

Many commercially available solid power dispensing devices, which do not invoke imparting charges to the powder particles, may be used to meter and dispense powders of mixed solid particles (e.g., powder discharger, automated powder dispenser, powder metering and dispensing device, gravimetric solid dispenser, etc.). The same type of solid powder mixture described in the previous paragraph was simply metered and dispensed, using a commercially available powder dispenser, onto a graphene-coated aluminum foil substrate to form a layer; the layer thickness was varied from approximately 55 μm to 1,220 μm for different layers. These layers were heated and roll-pressed to form cathode layers of approximately 25 to 350 μm in thickness. The opposing primary surface of a graphene-coated Al foil was then deposited with a Si-based anode layer to make a bipolar electrode.

Solid-state PVDF-HFP polymer electrolyte layers (intended to be used as separator layers) were prepared by dissolving PVDF-HFP and a lithium salt, lithium hexafluorophosphate (LiPF₆), in a solvent (a mixture of DMSO and acetone at an 1/1 volume ratio) to make a solution, which was (i) cast onto a pre-fabricated cathode layer to form a layer of PVDF-HFP (having a lithium salt dispersed therein) that was bonded to the cathode layer; (ii) a glass surface to make a solid-state PVDF-HFP separator layer, which was removed from the glass surface after drying to form a free-standing separator layer and then placed and bonded between the cathode layer of a bipolar electrode and the anode layer of a second bipolar electrode; and (iii) spray-dried to form PVDF-HFP solid powder, which was metered and dispensed onto a pre-made cathode layer and bonded with the cathode layer through heating and roll-pressing.

### EXAMPLE 7

### Bipolar Electrodes Comprising Prepared From Solid Powder Mixture Comprising Poly(Vinylidene Fluoride)-Hexafluoropropylene (PVDF-HFP) as a Polymer Electrolyte and LGPS as the Inorganic Solid-State Electrolyte

PVDF-HFP is dissolvable in a liquid solvent such as N,N′-dimethylformamide (DMF), N-methylpyrrolidone (NMP), dimethyl sulfoxide (DMSO), and acetone. We chose to use a mixture of DMSO and acetone (1/1 volume ratio) to dissolve a lithium salt (LiPF₆) up to a mole ratio of 0.8 at 45° C. and to dissolve PVDF-HFP up to 3% by weight to obtain a polymer solution. Then, 10% by weight (relative to the intended total composite layer weight) of nano particles of an inorganic solid-state electrolyte (LGPS prepared in Example 2), 1% by weight of carbon nanotubes (CNTs), 1% reduced graphene oxide sheets (from Angstron Materials, Inc.), 10% by weight of PVDF-HFP/LiPF₆, and 83% by weight of lithium iron phosphate (LFP) particles were dispersed in the polymer solution to obtain a slurry having a solid content of 10% by weight. The slurry was spray-dried to form a mixture of solid particles. This powder mixture was dispensed onto the first primary surface of a graphene-coated Al foil, followed by heating and roll-pressing to form a cathode layer-coated bipolar electrode. Several samples were prepared.

In one set of cathode layer-coated bipolar electrodes, the opposing primary surface of each electrode was left empty (without any anode active layer). Multiple bipolar electrodes (5 of them here) were then internally connected in series in such a manner that a polymer composite separator (specified below) was then disposed between a cathode layer of one bipolar electrode and an empty opposing primary surface of a neighboring bipolar electrode. Such a structure is a bipolar anodeless battery module.

In another set of samples, the second (opposing) primary surface of the graphene-coated Al foil was deposited with an anode layer comprising 83% of graphene-protected Si anode particles (from Honeycomb Battery Co., Dayton, Ohio), 2% by weight of carbon nanotubes (CNTs), 5% by weight of LGPS particles, and 10% by weight of PVDF-HFP/LiPF₆.

Further, specimens of a separator (solid-state electrolyte layer) comprising ⅓ of PVDF-HFP/LiPF₆ and ⅔ of LGPS particles were prepared in a similar manner, but no electrode active material and no electron-conducting additive were included in the solid powder mixture. The multiple layers of bipolar electrodes and separator layers were then alternately stacked (according to the sequence of FIG. 2(A)) and heated to 180° C. for 5 minutes under a pressure of 20 psi and subsequently cooled to room temperature to prepare a battery module. The anode, the separator, and the cathode layers in this module have the same PVDF-HFP-based polymer as part of a composite electrolyte.

A different set of bipolar modules were prepared by using a different type bipolar current collector. Instead of coating an anode layer on one primary surface and a cathode layer on the opposing primary surface of a graphene-protected Al foil, we coated a cathode layer on one primary surface (herein referred to as 1^{st} primary surface) of an Al foil, leaving the opposing or 2^{nd} surface “empty” (free from an anode layer), to obtain one half of a bipolar electrode. In addition, we coated an anode layer on one primary surface (3^{rd} primary surface) of a Cu foil, leaving the opposing (4^{th}) primary surface empty, to obtain the other half of the bipolar electrode. Then, we stack these two half electrodes, with the two empty surfaces matched and bonded together (2^{nd} surface mating 4^{th} surface), to produce a complete bipolar electrode. A plurality of bipolar electrodes were then stacked and bonded together, connected in series, to form a module, according to FIG. 2(A); in this case, a Cu foil and an Al foil were bonded together to become a bipolar current collector. The stack was heated to 180° C. for 5 minutes under a pressure of 20 psi and subsequently cooled to room temperature to prepare a battery module. Multiple bipolar modules were then connected in parallel to form a pack according to FIGS. 2(B) and 2(C).

### EXAMPLE 8

### Production of Bipolar Electrodes and Battery Packs Comprising a Poly(Acrylonitrile)-Based NCM-622 Cathode Layer

Poly(acrylonitrile) (PAN) is soluble in polar solvents, such as dimethylformamide (DMF), dimethylacetamide (DMAc), ethylene carbonate (EC) and propylene carbonate (PC), and in aqueous solutions of sodium thiocyanate, zinc chloride or nitric acid. The present study primarily made use of DMAc and EC as a solvent. A lithium salt (LiPF₆) was dissolved in EC for up to a mole ratio of 1.2 at 45° C. On a separate basis, 5% by weight of PAN was dissolved in EC to make a polymer solution. The EC/LiPF₆ solution was then mixed with the EC/PAN solution to form a mixture solution. Nano particles of LLZO (obtained in Example 3), along with cathode active material particles (NCM-622) and graphene sheets (as a conductive additive), were then dispersed in the mixture solution to obtain a slurry having a solid content of 4.5%. The amounts of particles and additives were added for the purpose of reaching the following weight %: LLZO (8%), PAN (10%), graphene sheets (2%), and NCM-622 (80%) in the polymer composite. The slurry was spray-dried to produce powder mixture of solid particles. The powder mixture was then poured onto a primary surface of a graphene-coated Al foil pre-positioned inside a cavity of a compression-molding mold in a hydraulic press. The powder mixture was then heated to slightly above the softening temperature of PAN (approximately 322° C.) and pressed into a cathode layer, which was naturally cooled to room temperature.

A separate set of samples were prepared by using a conventional slurry coating procedure to produce a porous cathode layer on a first primary surface of a bipolar current collector. In this procedure, particles of LLZO, NCM-622 cathode material, graphene sheets, and PVDF (as a binder resin) were dispersed in NMP solvent to form a slurry. A layer of slurry was then coated on a surface of Al foil; upon drying a cathode layer was formed having pores. The same mixture solution of EC/PAN/LiPF₆ was then sprayed over the porous cathode layer, allowing the solution to permeate into pores. The solvent was then removed with heat and a vacuum pump, leaving behind PAN containing LiPF₆ dispersed therein.

For the preparation of an ion-permeable separator, LLZO particles were dispersed in the EC/LiPF₆/PAN solution to form a paste, which was cast onto a glass surface to form a paste layer. The layer was then dried by vaporizing the solvent to form a separator which is a polymer composite electrolyte. Essentially five bipolar layers, each having a cathode layer deposited on one primary surface of a graphene-coated Al foil but no anode layer deposited on the opposing primary surface, and 4 separator layers were alternately stacked and series-connected to form a bipolar stacked. The stack was then subjected to a compressive stress (pressure of approximately 70 psi) using a hydraulic press for 5 minutes to make a consolidated bipolar anodeless lithium battery module. This module was then enclosed by a plastic-Al laminate envelop to make a bipolar battery pouch having two terminals sticking out of the protective housing.

Additionally, a group of battery packs was made by combining two halves of a bipolar electrode together with one half comprising an Al foil deposited with a cathode layer (procedure similar to that described above) on one primary surface (the other primary surface being empty) and the other half comprising a Cu foil coated with a thin layer of lithium metal (the other primary surface being empty). The empty surface of the Cu foil and the empty surface of the Al foil were then bonded together by using a thin layer of adhesive (18 nm thick) composed of graphene sheets dispersed in an epoxy resin. The two halves bonded together make a bipolar electrode.

### EXAMPLE 9

### Bipolar Battery Packs Containing Solid-State Electrolytes From Vinylphosphonic Acid (VPA)

The free radical polymerization of vinylphosphonic acid (VPA) can be catalyzed with benzoyl peroxide as the initiator. In a representative procedure, 150 parts vinylphosphonic acid, 0.75 parts benzoyl peroxide, and 20 parts of lithium bis(oxalato)borate (LiBOB) were dissolved in 150 parts isopropanol. A powder mass of LiCoO₂ particles was dispersed into this reactive mass to form a reactive slurry, which was dried to form reactive monomer-coated particles and then heated for 5 hours at 90° C. to form solid particles of polyvinylphosphonic acid-coated LiCoO₂ particles.

In a separate experiment, vinylphosphonic acid was heated to >45° C. (melting point of VPA=36° C.), which was added with benzoyl peroxide, LiBOB, and 25% by weight of a garnet-type solid electrolyte (Li₇La₃Zr₂O₁₂ (LLZO) powder). After rigorous stirring, the resulting paste was cast onto a surface of a layer of polyvinylphosphonic acid-coated LiCoO₂ particles, supported by a expanded graphite-coated Al foil, and the resulting three-layer structure was cured at 90° C., under a compressive stress, for 5 hours to form a solid electrolyte separator coated on a cathode.

For a bipolar lithium-ion battery, a natural graphite-based anode layer was deposited onto the opposing primary surface of the expanded graphite-coated Al foil as a bipolar current collector; the first primary surface was already deposited with a cathode layer. For an anode-less lithium battery, a LiCoO₂-based cathode layer was deposited on one primary surface of the expanded graphite-coated Al foil, but the opposing primary surface was not deposited with any lithium metal. Multiple (10) bipolar electrodes and 9 solid electrolyte separator layers were assembled into a bipolar battery. The batteries were then heated for 5 hours at 90° C. to form polyvinylphosphonic acid.

Electrochemical measurements (CV curves) were carried out in an electrochemical workstation at a scanning rate of 1-100 mV/s. The electrochemical performance of the bipolar batteries were evaluated by galvanostatic charge/discharge cycling at a current density of 50-500 mA/g using an Arbin electrochemical workstation. Testing results indicate that the batteries containing solid-state electrolytes perform very well, having higher energy densities and power densities as compared to battery modules having conventional liquid electrolyte-based lithium cells connected in series via wires. These bipolar batteries are flame resistant and relatively safe.

1. A method of producing a solid-state bipolar battery module or pack, the method comprising:
a) providing a first set of multiple bipolar electrodes and at least one or multiple ion-permeable separator layers, wherein at least one bipolar electrode is prepared by (A) providing a current collector comprising a conductive material foil having a thickness from 10 nm to 100 μm and two opposing primary surfaces, herein referred to as a first primary surface and a second primary surface, respectively; (B) preparing a positive electrode layer deposited on the first primary surface by (i) dispensing, spraying, coating, casting, or extruding to deposit a mixture of functional solid particles onto the first primary surface to form a mixture layer comprising solid particles of a cathode active material, an optional conductive additive, an optional binder resin, and a first polymer solid electrolyte having a lithium salt dispersed therein, being substantially free from a liquid solvent, and exhibiting a lithium ion conductivity no less than 1.0×10⁻⁸ S/cm at room temperature and (ii) optionally applying a pressure, heat, or both pressure and heat to consolidate said mixture layer to form said positive electrode layer; and (C) optionally depositing a negative electrode layer on the second primary surface wherein the negative electrode layer comprises a lithium metal layer or a layer of a mixture of solid particles of an anode active material, an optional conductive additive, an optional binder resin, a second polymer electrolyte having a lithium salt dispersed therein, which is different than or the same as the first electrolyte;
b) stacking the multiple bipolar electrodes alternately with said ion-permeable separator layers for connecting the multiple bipolar electrodes in series to form a stack in such a manner that an ion-permeable separator layer is disposed between the negative electrode layer of a bipolar electrode and the positive electrode layer of a neighboring bipolar electrode;
c) applying a pressure, heat, or both pressure and heat to the stack for a desired period of time to consolidate the stack for forming a battery module; and
d) optionally encasing the module with a protective housing element to form a pack.

2. The method of claim 1, wherein step b) and step c) further comprise forming at least another module in a similar manner and connecting the resulting multiple modules in parallel, and step d) comprises encasing the parallel-connected multiple modules with a protective housing element to form a pack.

3. The method of claim 1, wherein the pressure in step c) is from 0.1 to 1,000 psi, the temperature is from 25° C. to 400° C., and the period of time is from 10 seconds to 5 hours.

4. The method of claim 1, wherein the cathode layer, the anode layer, or the ion-permeable separator layer further comprises particles of an inorganic solid-state electrolyte and/or particles of a ceramic or glass material.

5. The method of claim 4, wherein said inorganic solid electrolyte is selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof and wherein the particles of ceramic or glass material is selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

6. The method of claim 1, wherein the first or second polymer electrolyte comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

7. The method of claim 1, wherein the negative electrode layer in step a) is produced by (i) spraying, coating, casting, or extruding to deposit a mixture layer of functional solid particles onto the second primary surface to form a mixture layer comprising solid particles of an anode active material, an optional conductive additive, an optional binder resin, and a second polymer electrolyte having a lithium salt dispersed therein, which is a solid polymer electrolyte being substantially free from a liquid solvent and having a lithium ion conductivity no less than 1.0×10⁻⁸ S/cm at room temperature and (ii) optionally applying a pressure, heat, or both pressure and heat to consolidate said mixture layer to form said negative electrode layer.

8. The method of claim 1, wherein at least one of the ion-permeable separator layers in step b) is selected from a porous polymer membrane, a nonwoven fabric, a polymer electrolyte, an inorganic solid-state electrolyte, a polymer composite electrolyte comprising particles of an inorganic solid-state electrolyte dispersed in a polymer matrix, or a polymer composite electrolyte comprising particles of a ceramic or glass material dispersed in a polymer matrix.

9. The method of claim 8, wherein the particles of ceramic or glass material is selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

10. The method of claim 8, wherein at least one of the ion-permeable separator layers is prepared by (i) spraying, coating, casting, or extruding to deposit a mixture layer of solid particles onto a surface of the negative electrode layer of a bipolar electrode and/or a surface of the positive electrode layer of a neighboring bipolar electrode to form a mixture layer comprising a polymer and solid particles of an inorganic solid electrolyte and/or solid particles of a ceramic or glass material and (ii) optionally applying a pressure, heat, or both pressure and heat to consolidate said mixture layer to form said ion-permeable separator layer.

11. The method of claim 1, wherein at least one of the ion-permeable separator layers, positive electrode layers, and anode electrode layers comprises a flame retardant selected from an organic phosphorus compound, an inorganic phosphorus compound, a halogenated derivative thereof, or a combination thereof.

12. The method of claim 11, wherein the organic phosphorus compound or the inorganic phosphorus compound is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

13. The method of claim 1, wherein the method comprises at least one of the following procedures:
(i) depositing the positive electrode layer by dispensing or spraying a mixture of solid particles onto the first primary surface to form a mixture layer wherein the step of dispensing or spraying comprises metering and dispensing the mixture of solid particles to form a solid powder mixture layer having a thickness from 0.1 μm to 2,000 μm on the first primary surface with or without imparting charges to the solid powder mixture;
(ii) depositing the negative electrode layer by dispensing or spraying a mixture of solid particles onto the second primary surface to form a mixture layer wherein the step of dispensing or spraying comprises metering and dispensing the mixture of solid particles to form a solid powder mixture layer having a thickness from 0.1 μm to 2,000 μm on the second primary surface with or without imparting charges to the solid powder mixture, which comprises the mixture of solid particles of an anode active material, an optional conductive additive, an optional binder resin, a second polymer electrolyte having a lithium salt dispersed therein; and
(iii) depositing an ion-permeable separator layer by dispensing, onto a solid substrate surface, a solid powder mixture layer comprising a polymer and solid particles of an inorganic solid electrolyte and/or solid particles of a ceramic or glass material, wherein the solid substrate surface is a surface of a positive electrode layer, a negative electrode layer, or an ion-permeating membrane and wherein the dispensing procedure is conducted with or without imparting charges to the solid powder mixture.

14. The method of claim 1, wherein step a) or step b) comprises depositing a positive electrode layer, a negative electrode layer, and/or an ion-permeable separator layer in a reel-to-reel or roll-to-roll manner.

15. The method of claim 1, wherein a bipolar electrode is prepared in a reel-to-reel or roll-to-roll manner.

16. A method of producing a solid-state bipolar battery pack, the method comprising:
a. Providing a first set of multiple bipolar electrodes and at least one or multiple ion-permeable separator layers, wherein at least one bipolar electrode is prepared by (A) providing a first current collector comprising a first conductive material foil having a thickness from 10 nm to 100 μm and two opposing primary surfaces, herein referred to as a first primary surface and a second primary surface, respectively; (B) preparing a positive electrode layer disposed on the first primary surface to form a first half of the bipolar electrode, which is conducted by (i) dispensing, spraying, coating, casting, or extruding to deposit a mixture of functional solid particles onto the first primary surface to form a mixture layer comprising solid particles of a cathode active material, an optional conductive additive, an optional binder resin, and a first polymer electrolyte having a lithium salt dispersed therein, which is a solid polymer electrolyte being substantially free from a liquid solvent and having a lithium ion conductivity no less than 1.0×10⁻⁸ S/cm at room temperature and wherein the second surface is not deposited with a positive electrode layer or negative electrode layer; and (ii) optionally applying a pressure, heat, or both pressure and heat to consolidate said mixture layer to form said positive electrode layer; (C) providing a second current collector comprising a second conductive material foil, different than the first conductive material, having a thickness from 10 nm to 100 μm and two opposing primary surfaces, herein after referred to as the third primary surface and the fourth primary surface, respectively; and (D) either depositing a negative electrode layer on the third primary surface or initially having no negative electrode layer deposited on said third primary surface to obtain a second half of the bipolar electrode, wherein the negative electrode layer, if present, comprises (i) a lithium metal layer and/or (ii) a layer of a mixture of particles of an anode active material, an optional conductive additive, an optional binder resin, and a second polymer electrolyte comprising a lithium salt dispersed therein, and wherein the fourth surface is not deposited with a positive electrode layer or a negative electrode layer; and (E) combining the first half of the bipolar electrode and the second half of the bipolar electrode to form said bipolar electrode wherein the second primary surface and the fourth primary surface are mechanically compressed or chemically bonded together;
b. stacking the multiple bipolar electrodes alternately with said layers of ion-permeable separator for connecting multiple bipolar electrodes in series to form a stack in such a manner that a layer of ion-permeable separator is disposed between the negative electrode layer of a bipolar electrode and the positive electrode layer of a neighboring bipolar electrode;
c. applying a pressure, heat, or both pressure and heat to the stack for a desired period of time to consolidate the stack for forming a battery module or pack; and
d. optionally encasing the module or pack with a housing element to form a bipolar pack.

17. The method of claim 16, wherein step b) and step c) further comprise forming at least another module in a similar manner and connecting the resulting multiple modules in parallel, and step d) comprises encasing the parallel-connected multiple modules with a protective housing element to form a pack.

18. The method of claim 16, wherein said lithium salt is selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

19. The method of claim 16, wherein the first or second polymer electrolyte comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

20. The method of claim 16, wherein the ion-permeable separator layer is selected from a porous polymer membrane, a nonwoven fabric, a polymer electrolyte, an inorganic solid-state electrolyte, a polymer composite electrolyte comprising particles of an inorganic solid-state electrolyte dispersed in a polymer matrix, or a polymer composite electrolyte comprising particles of a ceramic or glass material dispersed in a polymer matrix.

21. The method of claim 16, wherein the positive electrode layer or negative electrode layer further comprises particles of an inorganic solid electrolyte selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof, or wherein the positive electrode layer or negative electrode layer further comprises particles of ceramic or glass material selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

22. The method of claim 16, wherein the positive electrode or cathode comprises a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2), sulfur (S), lithium sulfide (LiₓS, x=1-8), a sulfur-containing compound, selenium (Se), lithium selenide (LiₓS, x=1-8), a selenium-containing compound, or a combination thereof.

23. The method of claim 16, wherein the negative electrode layer comprises an anode active material selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles; (g) prelithiated versions thereof; and (h) combinations thereof.
